(19) United States
(12) Patent Application Publication
(10) Pub. No.: US 2024/0273165 A1
(43) Pub. Date: Aug. 15, 2024

(54) REDUCTION OF CAPTURE LATENCY IN ACTIVE-ACTIVE SOLUTION

(71) Applicant: INTERNATIONAL BUSINESS MACHINES CORPORATION, Armonk, NY (US)

(72) Inventors: Bo Chen ZHU, Xi'an (CN); Mai ZENG, Shi Jing Shan (CN); Xin Xin DONG, Beijing (CN); Ming Qiao SHANG GUAN, Haidian District (CN); Wei SONG, Beijing (CN); Tian Ming PAN, Beijing (CN); Wen Zhong LIU, BEIJING (CN)

(21) Appl. No.: 18/107,799

(22) Filed: Feb. 9, 2023

(51) Int. Cl. G06F 18/232; G06F 18/10

(52) U.S. Cl. CPC G06F 18/232; G06F 18/10

(57) ABSTRACT

A system, method, and computer program product include: collecting runtime history capture data by a data agent operable on a computing device; performing a pre-analysis of entries in the history capture data, the history capture data including a plurality of database transactions corresponding to user tables, and providing formatted history capture data; clustering the formatted history capture data into clusters by data characteristics of interval groups; performing a post-analysis on the clusters and providing a unit data profile for capture data of the user tables; and dynamically updating capture policies corresponding to capture processes for the user tables, the updating based at least on the unit data profile provided by the post-analysis. In some embodiments the clustering is density based. Optionally, an alert is sent when capture process capacity is exceeded.

### BACKGROUND

Aspects of the present invention relate generally to database latency and, more particularly, to reduction of capture latency in an active-active solution for database backup and mirror storage. In general, an active-active solution may include at least two nodes, both actively running the same kind of service simultaneously. One purpose of an active-active cluster is to achieve load balancing. In an active-active disaster recovery architecture, an active-active architecture may use a stretched clustering configuration. In an example, an active-active disaster recovery architecture is the deployment of a second identical live infrastructure site which continually replicates with a first site.

A typical database system requires periodic backup or mirroring of data to ensure that there is no data loss of data or uptime service if the primary database storage has a power outage, hardware failure, or other event.

### SUMMARY

In a first aspect of the invention, there is a computer-implemented method including: collecting runtime history capture data by a data agent operable on a computing device; performing a pre-analysis of entries in the history capture data, the history capture data including a plurality of database transactions corresponding to user tables, and providing formatted history capture data; clustering the formatted history capture data into clusters by data characteristics of interval groups; performing a post-analysis on the clusters and providing a unit data profile for capture data of the user tables; and dynamically updating capture policies corresponding to capture processes for the user tables, the updating based at least on the unit data profile provided by the post-analysis.

In another aspect of the invention, there is a computer program product including one or more computer readable storage media having program instructions collectively stored on the one or more computer readable storage media. The program instructions are executable to: collect runtime history capture data by a data agent operable on a computing device; perform a pre-analysis of entries in the history capture data, the history capture data including a plurality of database transactions corresponding to user tables, and providing formatted history capture data; cluster the formatted history capture data into clusters by data characteristics of interval groups; perform a post-analysis on the clusters and providing a unit data profile for capture data of the user tables; and dynamically update capture policies corresponding to capture processes for the user tables, the updating based at least on the unit data profile provided by the post-analysis.

In another aspect of the invention, there is system including a processor set, one or more computer readable storage media, and program instructions collectively stored on the one or more computer readable storage media. and program instructions collectively stored on the one or more computer readable storage media. The program instructions are executable to: collect runtime history capture data by a data agent operable on a computing device; perform a pre-analysis of entries in the history capture data, the history capture data including a plurality of database transactions corresponding to user tables, and providing formatted history capture data; cluster the formatted history capture data into clusters by data characteristics of interval groups using a density based cluster operation of workload capture data, and provide a clustering group set; perform a post-analysis on the clusters and provide a unit data profile for capture data of the user tables; and dynamically update capture policies corresponding to capture processes for the user tables, the updating based at least on the unit data profile provided by the post-analysis.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment, according to an embodiment of the present invention.

FIG. 2 a flowchart of an exemplary method for capture latency reduction, in accordance with aspects of the invention.

FIGS. 3A-B show a block diagram depicting capture latency in a database backup scenario, in accordance with aspects of the invention.

FIG. 4 shows a block diagram of an exemplary environment, in accordance with aspects of the invention.

FIG. 5 shows a flowchart of an exemplary method for pre-analysis, in accordance with aspects of the invention.

FIG. 6 shows a flowchart of an exemplary method for post-analysis, in accordance with aspects of the invention.

FIG. 7 illustrates an example distribution curve for a validation set for pre-analysis, in accordance with aspects of the invention.

FIG. 8 shows an exemplary implementation of a data capture policy, in accordance with aspects of the invention.

### DETAILED DESCRIPTION

Aspects of the present invention relate generally to database latency and, more particularly, to reduction of capture latency in an active-active solution for database backup and mirror storage. According to aspects of the invention, measurement of workloads in a time interval is used to better predict future peak workload of the database. Using the future workload estimate enables the capture policy to be dynamically modified to accommodate the expected workload, thereby reducing the capture latency.

When there is a significant latency in the copying or mirroring of the user tables in the database, users may experience a delay in accessing and updating data. This delay can be a mere annoyance, or significantly affect the accuracy and efficiency of applications that use the database. For life critical applications, this latency can be unacceptable.

In database capture, an active-active solution needs to ensure the recovery time objective (RTO) and recovery point objective (RPO) into a service level agreement (SLA) are met, where the end-to-end latency is the foundation for both RTO and RPO. Therefore, the performance of the software data replication is advantageous to make sure the latency is within a reasonable threshold. From a customer's perspective, a performance bottleneck in the section of the capture latency often occurs, especially during a nightly heavy batch time range. In an example, the end-to-end latency request should be within 60 seconds even in a heavy batch time for a major client. However, the worst latency could be more than 1800 seconds which is often caused by capture latency during the user table capture for mirror operations.

Embodiments of the invention provide a method to reduce the capture latency in an active-active solution by proactive adoption, i.e., dynamically updating capture policies, according to the resource and capacity of the capture processes. A new metric is introduced to describe the capacity of the capture process, and based on historical data analysis, the incoming capture data for each unit is predicted. As used in the disclosure herein, a “unit” typically refers to a user table which is the unit of data captured by a capture process. Each user table in the database may have its own capture process. It will be understood that other implementations of database capture may be designed where a unit may include more than one user table, or another set of data elements. In that case, the unit will refer to the set of elements captured by the capture process and recorded in a historical capture database. The capture policy is proactively adapted to fulfill the SLA based on potential capacity of the capture processes. In an embodiment, latency is reduced by adjusting the capture policy to balance the workload between the various capture processes. Embodiments provide a quick, accurate estimation of the incoming capture workload for balancing.

Embodiments described herein include a system, computer implemented method and computer program product arranged to perform reduction of capture latency in an active-active solution. In an aspect of an embodiment, a history recovery log data, referred to herein as history capture data for simplicity, is input to a pre-analysis module to be formatted for the next step analysis. The capture data includes the raw data format and the cell separate to ensure that the data can be backed up by the current clustering algorithm. In an embodiment, the formatted data is input to a clustering module using density-based algorithms corresponding to the data characteristics. Based on the clustering result, a post-analysis is performed to ensure the data backup policy can be used in runtime. A new unit data profile is created as the result of post-analysis. As the guide of the policy, the unit data profile is input into a capture policy to generate a default policy for initial capture. During runtime, the capture process will start capture with the default capture policy. A data agent is launched to record the workload of capture data, then input to the capture policy by time interval. The capture policy dynamically generates an adapted, i.e., updated, capture policy and refers to the unit data profile proactively. The new capture policy is applied to the capture process to reduce the capture latency.

Implementations of various embodiments may provide an improvement in the technical field of capture latency and workload balancing during data capture and replication. In particular, the capture latency method includes various techniques for utilizing historical data analysis to predict workload balance of user tables. A capture policy for balancing the data capture workload is customized based on the historical data capture to reduce latency in the data replication. As such, modification of the capture policy may change the state of the storage devices and workload balancing modules, for instance, by changing the order in which user tables in the database are captured. Other predetermined actions include sending notifications or alerts to operators and/or users.

It should be understood that, to the extent implementations of the invention collect, store, or employ personal information provided by, or obtained from, individuals (for example, database contents), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

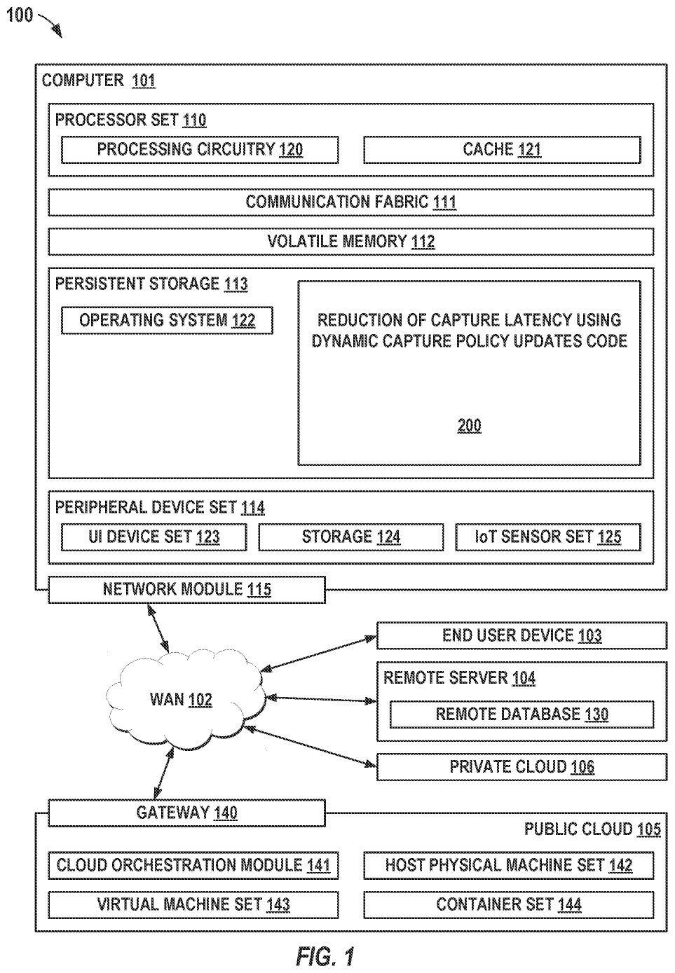

FIG. 1 depicts a computing environment 100, according to an exemplary embodiment of the present invention. While FIG. 1 shows a single computer 101 which may communicate over a network 102, it will be understood the various aspects of the described embodiments will be implemented on one or more remote servers to provide data capture and replication for databases which may reside in a single storage media, or be distributed over multiple storage media.

Computing environment 100 contains an example of an environment for the execution of at least some of the computer code involved in performing the inventive methods, such as reduction of capture latency using dynamic capture policy updates code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

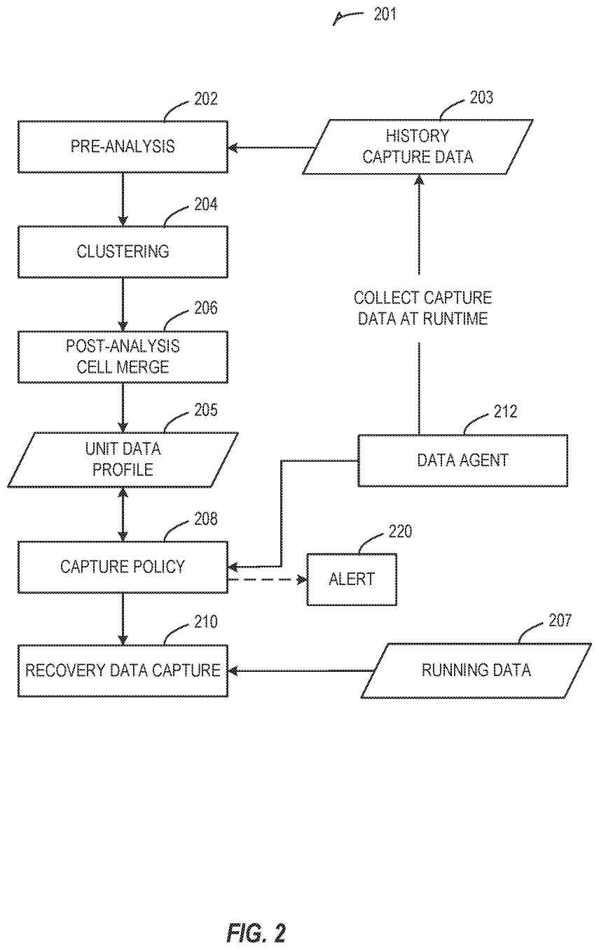

FIG. 2 is a flowchart of an exemplary capture latency reduction method 201, in accordance with aspects of the invention. Latency reduction method 201 may be implemented in computer code 200 (FIG. 1) as program instructions in software, hardware, firmware, or any combination thereof. Computer code 200 may include processes for the pre-analysis and post-analysis of the historical capture data and implementation of a dynamically modifiable capture policies for management of data capture and replication. The historical data analysis may include computer code for clustering using a density based model. The capture policy defines which data is to be collected in a particular order and by a particular processor or logic unit and is dynamically modifiable to improve throughput and reduce latency during runtime. Each unit, or user table, may have its own capture policy.

In an exemplary embodiment, input data of a history capture log or a database recovery log, herein referred to as history capture data 203, is retrieved by a pre-analysis module in block 202. The history capture data 203 includes the raw data format and the cell separate information to ensure that the data can be collected by the current clustering algorithm. Pre-analysis module at block 202 reformats the data for use by a clustering module.

There are many clustering algorithms available. Categories of clustering algorithms include partitioning, hierarchical, density based, graph theory, and other miscellaneous algorithms. Each clustering algorithm has its own advantages and disadvantages. Partitioning clustering includes K-Mean, K-MEDOIDS, and CLARANS methods. However, Without K identification, the complexity is NP (nondeterministic polynomial time) which is quite large. There is a requirement to identify medoids. Also, neighbors must be checked to determine if the K-MEDOIDS is the better medoids. Hierarchical methods include balanced iterative reducing and clustering using hierarchies (BIRCH) and Clustering Using Representative (CURE). BIRCH needs more information for pre-definition, and CURE cannot apply to large databases because it must consider every input as the initial tree node, and then merge them until the cluster is less than a pre-defined k. Graph theory includes shared nearest neighbor (SNN) k nearest neighbor (KNN). These algorithms need to find a way to transmit the data to a graph. Miscellaneous methods include grade based and model based algorithms. Grade based algorithms require high calculations and if the input data set is changed, it is difficult to adjust. Thus, dynamic policy changes may be difficult. Model based algorithms require more pre-definition and are difficult to implement. Lastly, density based algorithms include density-based spatial clustering of applications with noise (DBSCAN) and ordering points to identify the clustering structure (OPTICS). DBSCAN uses global optimization but cannot find the cluster with different densities. OPTICS is like DBSCAN, but still needs minimum samples (minpts) to reduce the incorrect assigned noise.

Embodiments as described herein use a density based clustering method 204. There are several known density based clustering algorithms. For embodiments described herein, the density based algorithm may be selected from any known algorithm, or use an algorithm to be developed in the future. The formatted data is input to clustering module at block 204, which uses density-based clustering algorithms according to the data characteristics. Further detail on clustering is discussed below.

Based on the clustering result, a post-analysis module at block 206 determines whether the current capture policy can be used efficiently during runtime. A new unit data profile 205 is generated as a result of the post-analysis at block 206. As discussed above, the unit data profile corresponds to the unit of data collected by each capture process according to policy. It will be understood that the capture process is often referred to as a “capture engine” in current industry nomenclature, which is just another term for program instructions to perform the data capture of a unit, according to a pre-defined capture policy. As described herein, the capture engine is referred to as “capture process.” In the example illustrated herein, the unit is a user table. As the guide of the capture policy, the unit data profile 205 is input into the capture policy at block 208 to generate a default policy for initial capture.

During runtime, the capture process at block 210 starts capture of running data 207 using the default policy. A data agent module at block 212 collects and records the workload of capture data and stores the historical transaction or workload data to a log referred to as history capture data 203. The workload capture data is input to the capture policy at block 208, by interval groups, i.e., groups of time intervals. The capture policy module at block 208 dynamically generates the adapted capture policy and refers to the unit data profile 205 proactively. The new capture policy (updated at block 208) will be dynamically applied to the capture process for recovery data capture at block 210 to reduce the capture latency.

In an embodiment, the capture policy at block 208 alerts the user to limit the workload if the capture policy change cannot fulfill the SLA, i.e., the workload exceeds the capacity of the capture process.

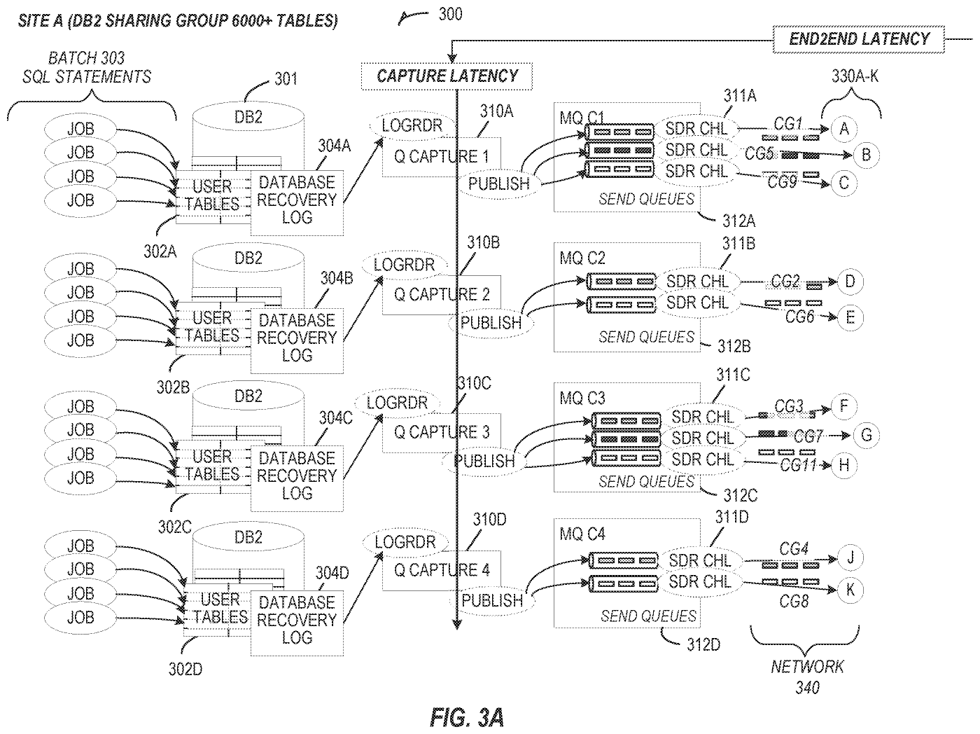

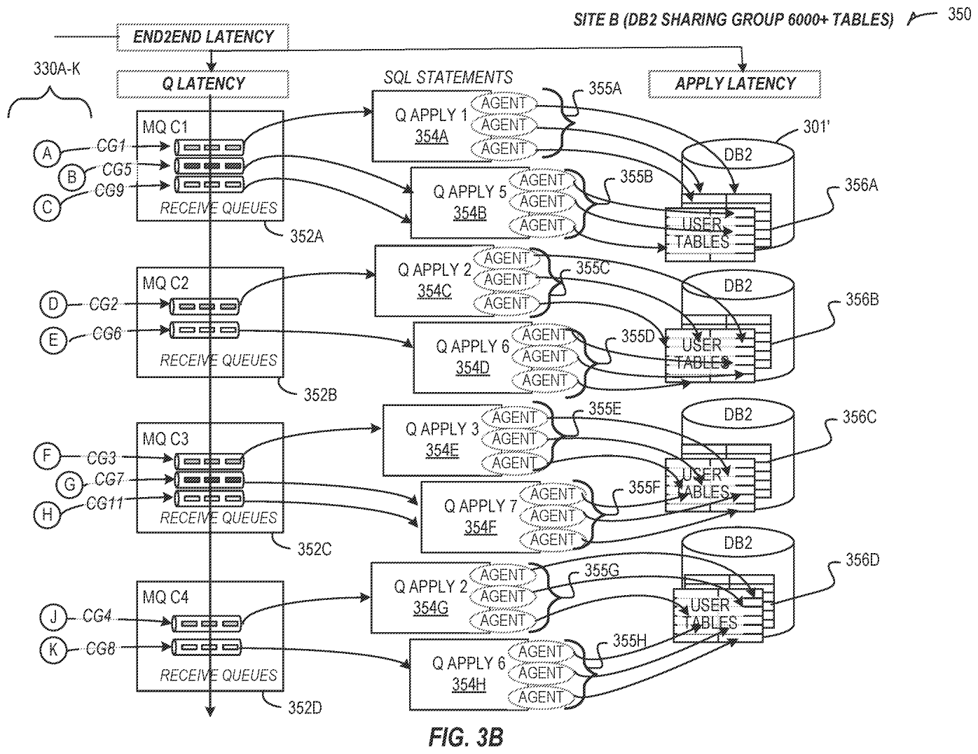

FIGS. 3A-B show a block diagram depicting capture latency in a database backup scenario, in accordance with aspects of the invention. FIGS. 3A and 3B depict a typical active-to-active solution for database capture for recovery including capture latency. FIG. 3A depicts the source database at Site A 300, and FIG. 3B depicts the recovery database at Site B 350. Referring to FIG. 3A, a typical system is shown for illustrative purposes that requires data capture and storing of the captured data for possible recovery operations. The mirror, or recovery database, is often stored at a separate physical site. For illustrative purposes Site A 300 and mirror site 350 (FIG. 3B) are shown. When an active-active site recovery database is implemented, transactions can be switched to the mirror site very quickly in case of failure at the primary site.

In this example, Site A 300 is the primary site until a failure or outage occurs that requires a mirror site to become primary. Such a typical system will include at least one database 301 with multiple user tables 302A-D. As users execute batch SQL statements 303, for instance, the data in the user tables 302A-D may change. A database recovery log 304A-D is updated as each user table 302A-D is modified. The size of each database recovery log 304A-D depends on the number of SQL statements 303 performed in the time interval between capture. It will be understood that each database recovery log 304A-D will be a different size based on the number of SQL statements executed. The size of the database recovery logs 304A-D may cause the Q capture processes 310A-D to execute inefficiently based on a capture policy that manages the capture process. It will be understood that the terms Q capture 310A-D and Q apply and 354A-H are used in the discussion of FIGS. 3A and 3B to be consistent with industry terminology for active-active solutions. In existing systems, the capture policy is often manually designed by a database administrator/engineer and remains static. Thus, when operational conditions change with respect to database access, the capture policy can become inefficient, and a significant capture latency may be inadvertently introduced. For instance, if a database recovery log becomes too large, the capture policy may exceed the capacity of one or more Q capture processes 310A-D.

Problems with implementations in the current state of the art exhibit capture latency during the capture of data and the receipt of the data at the recovery site when capacity is exceeded. Latency is the time it takes for a packet of data to travel from the source to a destination. In terms of performance optimization, it is important to optimize to reduce causes of latency. In this example architecture, the current approach is for the Q capture processes 310A-D to read the database recovery logs 304A-D to identify which user tables 302A-D are required to capture for recovery in a specific time interval. Each database recovery log 304A-D must be serviced by the Q capture processes 310A-D in a time interval before the user tables 302A-D can be accessed with additional SQL processing by users. Thus, capture latency can seriously affect user access to the data and may violate an SLA for the database service. Embodiments as described herein balance the workload among the Q capture processes 310A-D.

Q capture processes 310A-D are performed to capture the user table data 302A-D in preparation for mirroring the data to another site 350. The Q capture processes 310A-D capture user tables 302A-D based on a capture policy. The capture policy determines which user tables are captured by various sender channels 311A-D and passed through send queues 312A-D. In this illustration, send queue 312A includes three sender channels 311A. Send queue 312B includes two sender channels 311B. Send queue 312C includes three sender channels 311C. And Send queue 312D includes two sender channels 311D. The captured data 330A-K is sent to site B 350 over a network 340 such as the network 102 shown in FIG. 1.

In an example, the capture policy defines which user tables each Q capture process will receive, and in which order. For instance, in an example policy, Q capture process 310A may be configured to read the database recovery log 304A and capture user tables 302A. Once captured, the capture policy dictates which sender channels 311A in send queue 312A provide the various user tables as captured data 330A-C across network 340 to the receive queue 352A at site B 350 in mirrored database 301′. It will be understood that capture policies corresponding to capture processes 310A-D in existing systems are static.

Referring to FIG. 3B, capture data 330A-K is received by receive queues 352A-D at site B 350. Q apply processes 354A-H apply the data to mirrored user tables 356A-D using agents 355A-H. The order in which the captured data 330A-K is stored in the mirrored user tables 356A-D is defined by the capture policy. A goal is to reduce latency during the capture and storage of mirror data so that locking or unavailability of the user tables is minimized and/or avoided altogether.

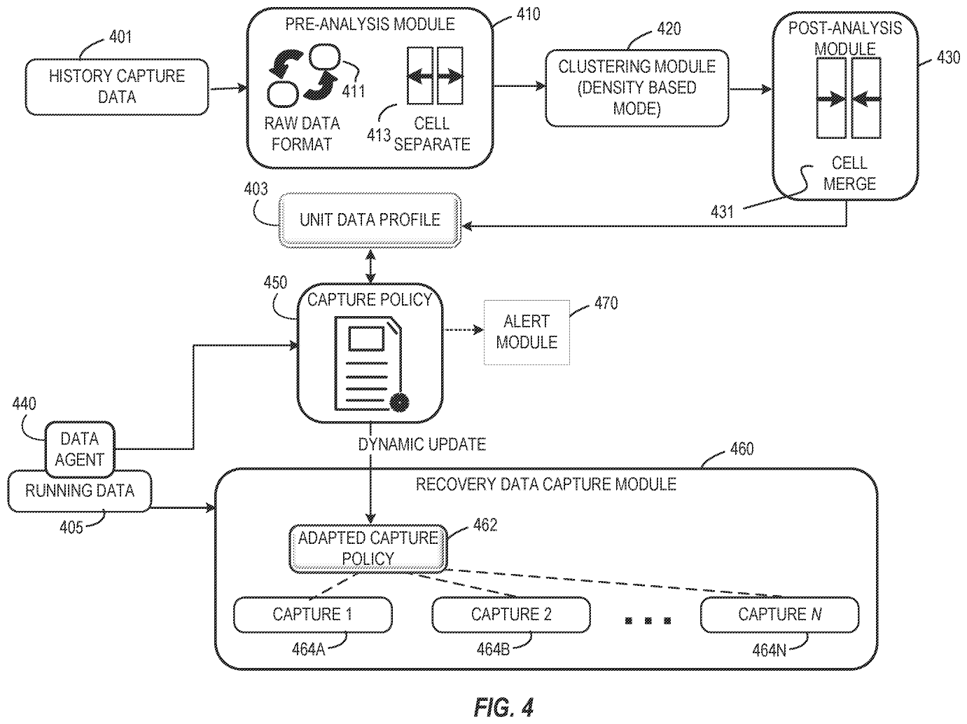

FIG. 4 shows a block diagram of an exemplary environment, in accordance with aspects of the invention. In embodiments, the system for reduction of capture latency of FIG. 4 comprises a pre-analysis module 410 using historical capture data 401, a clustering module 420, a post-analysis module 430 providing a unit (user table) data profile, and a dynamically adaptable capture policy 450 driving capture processes for the user tables which are to be captured. A data agent 440 collects the historical capture data using running data 405. Optionally, an alert module 470 provides varying levels of alerts when capture process throughput is predicted to exceed capacity. Each of the modules described herein may comprise modules of the code of block 200 of FIG. 1. These modules of the code of block 200 are executable by the processing circuitry 120 of FIG. 1 to perform the inventive methods as described herein. The system for reduction of capture latency using dynamic capture policy updates may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

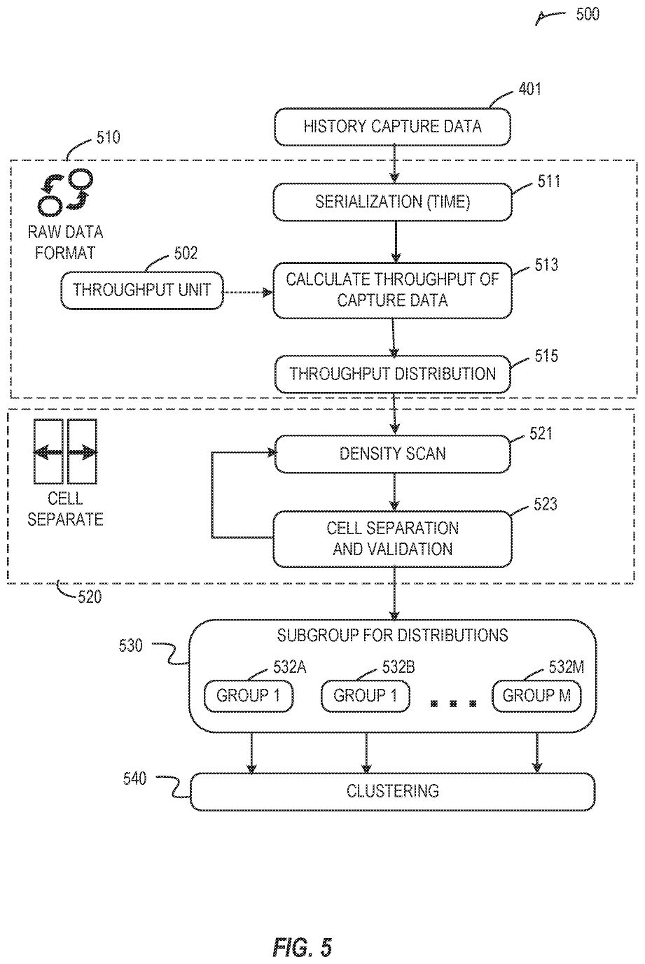

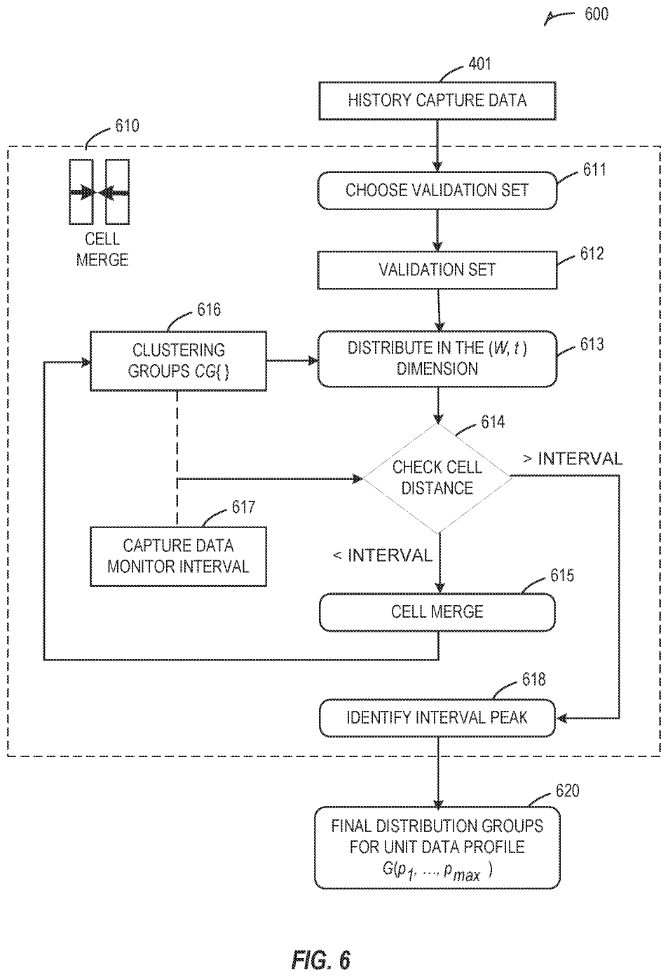

Referring again specifically to FIG. 4, a pre-analysis module 410 receives the history capture data 401. The history capture data 401 is provided in a raw data format 411. A cell separate function 413 is performed on the data which formats the data to be used by a clustering model 420. Pre-analysis is discussed in more detail in conjunction with FIG. 5. In an embodiment, the clustering module 420 uses a density based model algorithm. Once the history capture data has been clustered, the results are provided to a post-analysis module 430 which performs a cell merge operation 431. The cell merge combines cells that are close in distance. Post-analysis module is discussed in more detail in conjunction with FIG. 6.

Post-analysis module 430 provides a unit data profile 403 which is used to update the capture policy 450. It will be understood that as described herein, a “unit” refers to a unit of data to be captured which is typically a user table, such as user tables 302A-D of database 301 (FIG. 3A). When updated, the new or adapted capture policy 462 is adopted by the recovery data capture module 460. The adapted capture policy 462 provides modified policies for each capture process 464A-N, such as the Q capture processes 310A-D of FIG. 3A, which provide a capture process to optimize a reduction in latency.

Running data 405 is generated as the system is running, i.e., during runtime, and generates runtime workload capture log information. Data agent 440 records the workload capture data, i.e., running data 405, which is provided to the capture policy 450. An alert is optionally provided by alert module 470 to the database administrator to notify them of any overloads to the workloads, or if a capacity is exceeded to violate the SLA. For instance, after balancing the workloads, their capacity may still be exceeded. The alert provided may indicate that additional capture processes and other resources are required for the size and activity of the database.

In existing systems, historical capture data directly informed a static capture policy, typically manually generated. Embodiments as described herein, use pre-analysis module 410 and post-analysis module 430 to better predict future workloads and allow for dynamic adaption of the capture policies 462.

FIG. 5 shows a flowchart of an exemplary method 500 for pre-analysis, in accordance with aspects of the invention. It should be noted that pre-analysis is performed for each user table, or unit. Specific terms are used to describe the pre-analysis function and are described herein. A throughput unit 502 is a unit to describe the throughput for capture data. Typically, the throughput unit should be recorded per second (r/sec). Serialization (time) 511 is the data formatted with the time of day (TOD) time stamp. A throughput W is calculated as W=C/T where C refers to the counting of the records that occur in the same time slot and the T refers to the time slot. In an example, t marks the middle time point of the slot as the time parameter. In an example, a time slot chosen might be from 9:00 PM to 9:05 PM. A new data group is generated as (W, t). These throughput groups are then distributed in the dimension of W to provide a throughput distribution.

In an embodiment, the database recovery log data, such as 304A-D of FIG. 3A, is referred to as history capture data 401, for simplicity. The history capture data 401 is provided to a submodule 510 of pre-analysis 500. The history capture data 401 is typically unformatted raw data used to identify the counts in a time slot, or interval. Serialization time 511 is associated with the elements of the history capture data. The throughput of the capture data is calculated at 513 using the throughput unit 502. The throughput distribution 515 is then provided to the density scan 521 of the cell separate submodule 520.

A density scan 521 is a scan of the throughput distribution 515 to find the edge of density. This scan can be done by the iteration process as described in operations 1-5, below.
1. Given a default density slot s (e.g., the minimum one depends on the scan effort), from the first slot, calculate the throughput distribution density D₁ as: D₁=d, where d is the number of the throughputs distributed in this slot.
2. Then the process goes to next slot, repeats operation 1 above, then compare D₂ and D₁:
   a. If D₁>D₂, then make D₁ in the peak set P, and make D₂ in the edge set E.
   b. If D₂>D₁, then make D₂ in the peak set P, and make D₁ in the edge set E.
3. Go to the next slot m, repeat operation 1 above, and compare Dₘ and Dₘ₋₁:
   a. If Dₘ>Dₘ₋₁ && Dₘ₋₁∈P, then make Dₘ in the peak set P instead of Dₘ₋₁, else make Dₘ in the peak set P.
   b. If Dₘ₋₁>Dₘ && Dₘ₋₁∈E, then make Dₘ in the edge set E instead of Dₘ₋₁, else make Dₘ in the edge set E.
4. Run the above operations until the end of distribution.
5. Return the edge set.

Once the density scan has identified the edges and peak sets, the information is provided to a cell separation and validation module at block 523. Cell separation and validation uses edge sets as the edge of the dimension W. There may be several groups. The separation is validated with the following operations 1-6, as described below.
1. Randomly select the data from a collection time period, such as one or more days, as the validation set.
2. Input the training set into the (W, t) dimension with the groups.
3. Check whether for each point, it is t continuous from one group G to another group H. In an example, t continuous means that comparing a peak in one group to another peak in the same day for another group, that the first peak continues to the other peak without an edge. In other words, it means that:
   a. ∀a∈G, where a is an element of group G,
   b. ∃set B [symbol] a, there exists a set B as an element of a, subject to,
   c. ∀x∈B, ∃y∈B, for all x an element of B, there exists y as element of B, where x and y are time slots, and
   d. ∥tₓ−t_{y}∥=minΔt & B∩NH≠Ø. In other words, the difference in time slots is equal to the minimum of the change in time and the intersection of the sets B and H is not null.
4. If a t continuous is found, it means that the time slot is small, so it should be increased (e.g., regrouped) and then the density scan 521 should be rerun.
5. The density scan 521 is to be rerun until there is point which is not t continuous from one group to another, and then stop the operation.
6. After cell separate 520, a subgroup for distributions 530 is generated. As illustrated, in the subgroup 530 there is a group 1 to group m 532A-M. For each group 532A-M, existing clustering (e.g., density based) 540 is used. Clustering group set CG{ } is returned at 540.

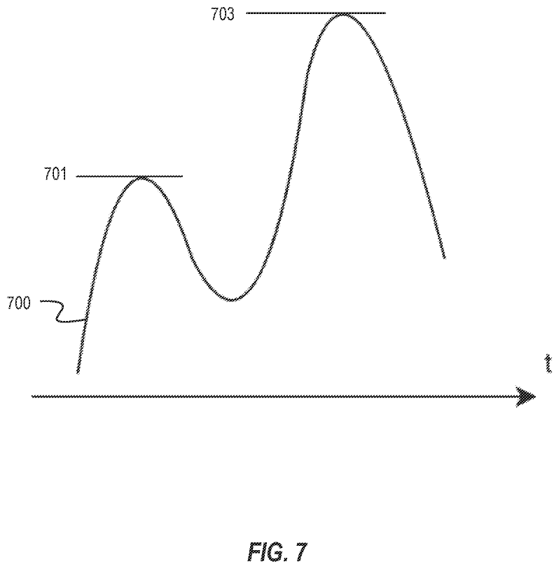

FIG. 7 illustrates an example distribution curve 700 for a validation set for cell separation 520, in accordance with aspects of the invention. In an example, a first peak 701 will be t continuous to a second peak 703, but with no edges. The data set has all peaks and edges recorded for a time period, such as a day. The cell separation will separate the cell-based peak and edge set. The validation will solve the curve 700.

FIG. 6 shows a flowchart of an exemplary method 600 for post-analysis, in accordance with aspects of the invention. History capture data 401 is provided to a cell merge module 610. Terms used in the description below are described herein. Clustering groups CG{ } are the result of clustering 540 (FIG. 5) of each subgroup. Each of clustering groups CG{ } contains the edge and throughput with a maximum density of Wₘ. The capture data monitor interval is the monitor interval from the data agent 440 (FIG. 4) for the capture data and is referred to as i.

A validation set 612 is randomly selected from days collected, in block 611. The validation set 612 is distributed in the (W,t) dimension in block 613. With the clustering groups CG{ } as input 616, the data from validation set 612 is input in the (W,t) dimension with different groups. The cell distance is checked in block 614 to determine intervals for cell merge at block 615. In an embodiment, checking the cell distance includes the following operations 1-7.
1. Get capture data monitor interval i as parameter.
2. For each cell Wₘ find the point x which has: min ∥Wₓ−Wₘ|, then record tₓ.
3. Calculate the cell t distance De between two nearby groups with: D_{c(A,B)}=∥tₓ−t_{y}∥, where A,B∈CG{ }, (x∈A, y∈B, subject to, min ∥Wₓ−Wₘₐ∥, min ∥W_{Y}−W_{mB}∥).
4. If D_{c(A,B)}<i, those 2 groups and cells need to be merged and the CG{ } will be updated, then repeat the validation with the updated CG { } until D_{c(A,B)}>i.

For each subgroup, find the interval peak pᵢ, at block 618, subject to:
5. If D D_{c(A,B)}>i, using i as the interval, then for each A∈CG{ }, define tₘ for as Wₘ as:

$${t}_{m} = avg ‖ {t}_{X} - {t}_{min} ‖ ( x ∈ A , subject to , min ‖ {W}_{X} - {W}_{m} ‖ , {t}_{min} = min {t}_{a} ( where a ∈ A )$$

where x, a belong to the same validation set.
6.

$$If {t}_{m} < i , make {p}_{1} = {W}_{m} .$$

$$If {t}_{m} > i , make {p}_{1} = {max}_{a ∈ A , ‖ {t}_{x} - {t}_{min} ‖ < i} {W}_{a} , then update {t}_{min} = {max}_{a ∈ A , ‖ {t}_{x} - {t}_{min} ‖ < i} {t}_{a} , repeat operation 6 to find next {p}_{n + 1} .$$

$${p}_{max} = {max}_{a ∈ A} {W}_{a} .$$

7. Return the distribution groups set G(p₁, . . . , pₘₐₓ) at block 620, and make the default set G_{d} for which group has the most density (new cell).

The distribution groups are used to provide a unit data profile for a unit, which is used to update the capture policy of the unit.

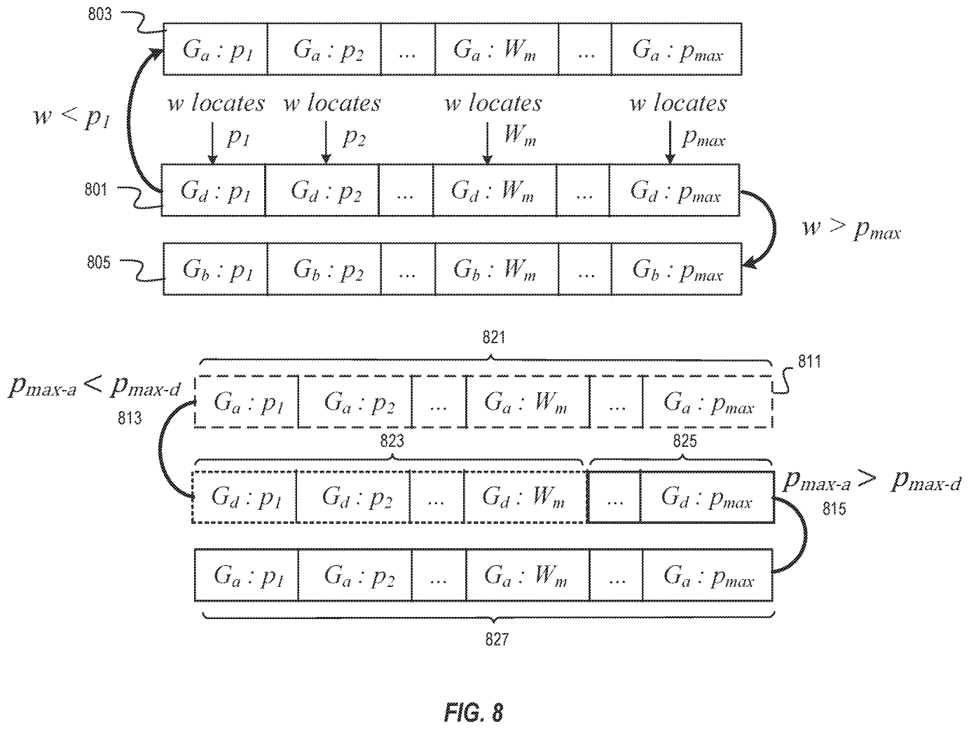

FIG. 8 shows an exemplary implementation of a capture policy, in accordance with aspects of the invention. It should be noted that groups for only one user table are illustrated. It will be understood that the same operations are performed for each user table in the database 301 and merged together to generate a comprehensive policy for all capture processes using a workload balancing algorithm. It will be understood that a variety of workload balancing algorithms may be used that are now known or to be developed in the future, using the information provided by the pre-analysis and post-analysis of the history capture data, as described above. In an embodiment, default group G_{d} 801 is the default expected workload for capture. The default group 801 has the highest density for the previous time interval throughput. Density from previous time intervals is used to estimate future intervals. In an example, a time interval for the previous 5 or 10 minutes may be used. Each group Gᵢ for the user table has an associated workload w and a peak pᵢ. After the data agent 440 has collected data for an interval, the current capture data amount w is collected, for instance, for group Gₐ 803. The location of workload w is identified, and the related peak pₘₐₓ is selected as the expected workload 805. In this context, location means location in the group where the workload is a member, so that the peak value can be selected. The existing capacity of the capture processes is calculated, and a new capture policy is generated, leveraging existing queueing or streaming theories.

If the group throughput information for Gₐ 803 is a smaller interval than the capture monitor interval of the data agent 440, then there will only be one measured throughput workload pₘₐₓ. If the group throughput information is a larger than the capture monitor interval, then each interval will have an associated p₁, p₂, Wₘ and Pₘₐₓ. In this case, the workload w is located in comparison with the default group Gd 801. In other words, for each monitor interval, there will be a maximum value of workload. If the interval is smaller than the capture monitor interval, there will be only one maximum workload. In this case, when the workload is monitored in a certain group, it means, in this interval, the maximum value of this sub-group will be reached. Then this value is used as the expected value to balance the workload to form the policy. The policy will assign the resource to each workload. For the next interval, the same process is used to adjust the policy.

As described above, an alert is optionally sent when the capture process capacity is exceeded. In an example, according to the current queuing and streaming theories, if the workload has reached the capacity of the capture process, there will be an alert to limit the workload which generates the capture data. The data agent 440 (FIG. 4) checks the current capture data amount, and returns the top units, i.e., user tables, which have the maximum workload w, by the different location with w in the group. The different level of alert will be reported, and assumes current group is Gₐ 811:

If p₍ₘₐₓ₋ₐ₎<p_{(max-d)} 813, it means there is a high probability that the workload 821 will grow much higher. In this case, the alert should be a highest priority.

If Gₐ=G_{d} & w≤Wₘ, it means that the workload will reach a higher level in the same group. In this case, for instance 823, the alert should be in the higher priority.

If p₍ₘₐₓ₋ₐ₎>p_{(max-d)} 815, it means that the workload is already in a high level and will probably not grow a lot. In this case, for instance for 825 and 827, the alert should be in low priority.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, or computing device such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
collecting, by a processor set, runtime history capture data by a data agent operable on a computing device;
performing, by the processor set, a pre-analysis of entries in the history capture data, the history capture data including a plurality of database transactions corresponding to user tables, and providing formatted history capture data;
clustering, by the processor set, the formatted history capture data into clusters by data characteristics of interval groups;
performing, by the processor set, a post-analysis on the clusters and providing a unit data profile for capture data of the user tables; and
dynamically updating, by the processor set, capture policies corresponding to capture processes for the user tables, the updating based at least on the unit data profile provided by the post-analysis.

2. The computer implemented method as recited in claim 1, wherein the pre-analysis further comprises:
serializing of the history capture data according to time-of-day timestamp information;
calculating throughput of workload capture data in the history capture data, and generating a throughput distribution;
performing a density scan of the throughput distribution;
performing cell separation of the workload capture data; and
validating the cell separation.

3. The computer implemented method as recited in claim 2, wherein the clustering comprises:
performing a density-based cluster operation on the validated cell separation of workload capture data; and
providing a clustering group set.

4. The computer implemented method as recited in claim 3, wherein the clustering group set includes edge and throughput data with a maximum workload density for a capture monitor interval.

5. The computer implemented method as recited in claim 3, wherein performing post-analysis further comprises:
selecting a validation set at random from a time interval of the clustering group set;
distributing a plurality of clustering groups using the validation set as a function of workload throughput for a time slot;
calculating a cell distance between groups;
merging two or more groups when the calculated cell distance between the two or more groups is below a pre-determined interval threshold;
updating the clustering group set when two or more groups have been merged;
generating a distribution group set with a default group having the highest density; and
providing the unit data profile based at least on the distribution group set.

6. The computer implemented method as recited in claim 1, wherein dynamically updating capture policies further comprises:
selecting a default group as an expected workload for capture;
selecting a peak workload from the history capture data for an interval;
calculating existing capacity of the capture processes;
generating an updated capture policy for at least one user table based at least on the existing capacity of the capture processes and the peak workload; and
automatically deploying the updated capture policy to the capture processes.

7. The computer implemented method as recited in claim 1, further comprising:
sending an alert when an expected workload for at least one capture process exceeds a pre-determined capacity of the at least one capture process.

8. A computer program product comprising one or more computer readable storage media having program instructions collectively stored on the one or more computer readable storage media, the program instructions executable to:
collect runtime history capture data by a data agent operable on a computing device;
perform a pre-analysis of entries in the history capture data, the history capture data including a plurality of database transactions corresponding to user tables, and providing formatted history capture data;
cluster the formatted history capture data into clusters by data characteristics of interval groups;
perform a post-analysis on the clusters and provide a unit data profile for capture data of the user tables; and
dynamically update capture policies corresponding to capture processes for the user tables, the updating based at least on the unit data profile provided by the post-analysis.

9. The computer program product as recited in claim 8, wherein the pre-analysis further comprises program instructions to:
serialize the history capture data according to time-of-day timestamp information;
calculate throughput of workload capture data in the history capture data, and generate a throughput distribution;
perform a density scan of the throughput distribution;
perform cell separation of the workload capture data; and
validate the cell separation.

10. The computer program product as recited in claim 9, wherein the clustering comprises program instructions to:
perform a density based cluster operation on the validated cell separation of workload capture data; and
provide a clustering group set.

11. The computer program product as recited in claim 10, wherein the clustering group set includes edge and throughput data with a maximum workload density for a capture monitor interval.

12. The computer program product as recited in claim 10, wherein performing post-analysis further comprises program instructions to:
select a validation set at random from a time interval of the clustering group set;
distribute a plurality of clustering groups using the validation set as a function of workload throughput for a time slot;
calculate a cell distance between groups;
merge two or more groups when the calculated cell distance between the two or more groups is below a pre-determined interval threshold;
update the clustering group set when two or more groups have been merged;
generate a distribution group set with a default group having the highest density; and
provide the unit data profile based at least on the distribution group set.

13. The computer program product as recited in claim 8, wherein dynamically updating capture policies further comprises program instructions to:
select a default group as an expected workload for capture;
select a peak workload from the history capture data for an interval;
calculate existing capacity of the capture processes;
generate an updated capture policy for at least one user table based at least on the existing capacity of the capture processes and the peak workload; and
automatically deploy the updated capture policy to the capture processes.

14. The computer program product as recited in claim 8, further comprising program instructions to:
send an alert when an expected workload for at least one capture process exceeds a pre-determined capacity of the at least one capture process.

15. A system comprising:
a processor set, one or more computer readable storage media, and program instructions collectively stored on the one or more computer readable storage media, the program instructions executable to:
collect runtime history capture data by a data agent operable on a computing device;
perform a pre-analysis of entries in the history capture data, the history capture data including a plurality of database transactions corresponding to user tables, and providing formatted history capture data;
cluster the formatted history capture data into clusters by data characteristics of interval groups using a density based cluster operation of workload capture data, and provide a clustering group set;
perform a post-analysis on the clusters and provide a unit data profile for capture data of the user tables; and
dynamically update capture policies corresponding to capture processes for the user tables, the updating based at least on the unit data profile provided by the post-analysis.

16. The system as recited in claim 15, wherein the pre-analysis further comprises program instructions to:
serialize the history capture data according to time-of-day timestamp information;
calculate throughput of workload capture data in the history capture data, and generate a throughput distribution;
perform a density scan of the throughput distribution;
perform cell separation of the workload capture data; and
validate the cell separation.

17. The system as recited in claim 16, wherein performing post-analysis further comprises program instructions to:
select a validation set at random from a time interval of the clustering group set;
distribute a plurality of clustering groups using the validation set as a function of workload throughput for a time slot;
calculate a cell distance between groups;
merge two or more groups when the calculated cell distance between the two or more groups is below a pre-determined interval threshold;
update the clustering group set when two or more groups have been merged;
generate a distribution group set with a default group having the highest density; and
provide the unit data profile based at least on the distribution group set.

18. The system as recited in claim 15, wherein the clustering group set includes edge and throughput data with a maximum workload density for a capture monitor interval.

19. The system as recited in claim 15, wherein dynamically updating capture policies further comprises program instructions to:
select a default group as an expected workload for capture;
select a peak workload from the history capture data for an interval;
calculate existing capacity of the capture processes;
generate an updated capture policy for at least one user table based at least on the existing capacity of the capture processes and the peak workload; and
automatically deploy the updated capture policy to the capture processes.

20. The system as recited in claim 15, further comprising program instructions to:
send an alert when an expected workload for at least one capture process exceeds a pre-determined capacity of the at least one capture process.
